(19) United States
(12) Patent Application Publication
(10) Pub. No.: US 2026/0200540 A1
(43) Pub. Date: Jul. 16, 2026

(54) VEHICLE AND AERODYNAMIC SKIRT FOR A VEHICLE

(71) Applicant: ZF CV Systems Europe BV, Brussels (BE)

(72) Inventors: Adrian Pochojka, Wroclaw (PL); Michael Rizoiu, Oakville (CA); Jim Haws, Ancaster (CA)

(21) Appl. No.: 19/016,966

(22) Filed: Jan. 10, 2025

(51) Int. Cl. B62D 35/00

(52) U.S. Cl. CPC B62D 35/001

(57) ABSTRACT

A vehicle includes an axle having a left wheelset with at least one wheel and a right wheelset with at least one wheel. The wheels have a common axis of rotation. A lateral axis is defined as parallel to the axis of rotation. A central plane is defined as perpendicular to the lateral axis and centered between the left and the right wheelset. The vehicle defines a forward direction, which is perpendicular to the lateral axis. The vehicle defines a rearward direction opposite to the forward direction. An outward direction is defined as a direction away from the central plane. An inward direction is defined as a direction toward the central plane. The vehicle has an aerodynamic skirt arranged in a forward projection of the axle. The aerodynamic skirt includes a curved portion that has a frontal end and is curved outward from the frontal end in the rearward direction.

### TECHNICAL FIELD

The disclosure relates to a vehicle and to an aerodynamic skirt for a vehicle.

### BACKGROUND

An aerodynamic skirt, also known as a trailer skirt or side fairing, is a device attached to the sides and sometimes the rear of a vehicle, such as a semi-tractor trailer or a straight truck. It serves the purpose of reducing aerodynamic drag, which in turn improves fuel efficiency and reduces emissions.

These skirts are typically made of lightweight, flexible materials such as plastic or composite materials. They extend downward from the bottom of a chassis of the trailer, creating a smooth surface that helps to direct airflow around the trailer more efficiently. By reducing the turbulence created by air hitting the underside of the trailer and the gap between the trailer and the road, aerodynamic skirts help to decrease the drag force acting on the vehicle.

The reduction in aerodynamic drag results in less energy required to propel the truck forward, leading to improved fuel efficiency. This is particularly important for long-haul trucking operations where fuel costs represent a significant portion of operating expenses. Improved fuel efficiency means reduced carbon dioxide emissions and other pollutants associated with burning fossil fuels. This helps companies meet environmental regulations and reduce their carbon footprint. Lower fuel consumption translates to cost savings for trucking companies over the long term. Despite the initial investment in purchasing and installing aerodynamic skirts, the fuel savings often outweigh the upfront costs, resulting in a positive return on investment. In some regions, there are regulations mandating the use of aerodynamic devices on commercial trucks to improve fuel efficiency and reduce emissions. Therefore, using aerodynamic skirts ensures compliance with these regulations.

Existing solutions are based mainly on straight skirts in the form of one single element or multiple segments without any additional elements attached to them. Sometimes, the aerodynamic skirts are corrugated to add stiffness. However, the aerodynamics are still not ideal.

### SUMMARY

This summary offers a basic introduction to selected aspects of the disclosed components and methods. It is not intended to be exhaustive, nor does it identify key elements or define the scope of the disclosure. Its purpose is strictly to introduce some concepts in a simplified form ahead of the detailed description that follows. The section headings are provided solely for convenience and should not be interpreted as limiting or definitive in any respect.

A vehicle includes an axle, wherein the axle includes a left wheelset including at least one wheel and a right wheelset including at least one wheel. The wheels include a common axis of rotation, wherein a lateral axis is defined as parallel to the axis of rotation. A central plane is defined as perpendicular to the lateral axis and centered between the left wheelset and the right wheelset. The vehicle includes a forward direction, which is perpendicular to the lateral axis. The vehicle includes a rearward direction opposite to the forward direction. An outward direction is defined as a direction away from the central plane. An inward direction is defined as a direction toward the central plane. The vehicle includes an aerodynamic skirt that is arranged in a forward projection of the axle. The aerodynamic skirt includes a curved portion that includes a frontal end and is curved outward from the frontal end in the rearward direction.

The terms “axis of rotation”, “lateral axis”, “central plane”, “forward direction”, “rearward direction”, “outward direction”, and “inward direction” provide for a geometric reference system and are not meant to refer to physical elements directly. A frontal end is generally an end of an element in the forward direction. A rear end is generally an end of an element in the rearward direction.

The description “curved outward” refers to the curved portion including a curvature that is positive with respect to the outward direction. In other words, the curve is between an inside of the curve and the central plane for a given position of the curve. The vehicle generally includes a right-hand side, that is right of the central plane with respect to the forward direction. The vehicle generally includes a left-hand side, that is left of the central plane with respect to the forward direction. On the right-hand side, a curved portion being curved outward in the rearward direction is a left curve when viewed from the top. On the left-hand side, a curved portion being curved outward is a right curve when viewed from the top.

The inventor has discovered that air generally tends to wrap around the bottom edge of an aerodynamic skirt, which increases the amount of air that flows under the vehicle and adds pressure to the vehicle chassis and wheels. The effect is similar to the situation at a wingtip of a plane, which creates a vortex of flowing air. The amount of air that flows beneath the aerodynamic skirt's bottom edge is increased due to the pressure difference between upwind and downwind side of the aerodynamic skirt. As a result of this pressure difference, a strong vortex wraps around the edge. The vortex causes the fresh air from outside to flow beneath the bottom edge of the panel and under the vehicle. This eventually increases the pressure at the chassis and wheels of the vehicle, which increases the drag.

Research has now shown that with a curved portion that is curved outward, the air stream flowing under the aerodynamic skirt is rather focused in an area of preferred detachment of the air stream from the skirt's bottom end. With a straight aerodynamic skirt, in comparison, the drag toward under the aerodynamic skirt is typically distributed quite evenly along its length.

The designer of the aerodynamic skirt can control the point of detachment of air from the bottom skirt edge via a curved portion being curved outward. Due to the curvature of the curved portion, the designer can focus the drag in a certain area. In this focus area, more air flows toward under the skirt compared to other areas. That typically happens at an angle with inward direction. Thus, a large amount of air will travel toward the central plane and after a while through an open space between the wheels. Between the wheels, there is less resistance toward the air flow compared to the area of the wheels themselves. Another result is that the air flowing through the open space between the wheels recovers some pressure behind the vehicle. That reduces the overall drag.

In general, the aerodynamic skirt may include more than one curved portion. Also, the aerodynamic skirt may include one or more straight portions. The straight portions may, for example, be parallel or arranged at an angle with respect to the central plane.

According to an embodiment, the frontal end of the curved portion is a frontal end of the aerodynamic skirt.

According to an embodiment, the curved portion includes a rear end, wherein the rear end of the curved portion is a rear end of the aerodynamic skirt.

Advantageous embodiments include that the curved portion includes a circular shape, a parabolic shape or a spline shape.

According to an embodiment, a rearward tangent vector at any given position of the curved portion is directed outward.

The curved portion may, according to another embodiment, be strictly monotonically curved outward from the frontal end in the rearward direction.

The curved portion may include a radius of curvature of at least 1 m, optionally at least 5 m, optionally at least 20 m. The curved portion may include a radius of curvature of at most 210 m, optionally at most 100 m, optionally at most 25 m, optionally at most 10 m, optionally at most 6 m, optionally at most 2 m. The curvature may be constant along the curved portion.

The aerodynamic skirt can generally have more than one curved portion. Shapes of different curved portions may be different. In general, a curved portion is completely curved. If the aerodynamic skirt is straight in part, such a part is referred to as a straight portion herein.

The curved portion may preferably include a length with respect to the rearward direction, that is, a length of a lateral projection of the curved portion onto the central plane. The length may be at least 0.1 m or at least 0.5 m or at least 1 m or at least 1.5 m or at least 3 m.

The length may be at most 7 m or at most 3 m or at most 2 m or at most 1 m.

According to an embodiment, the axle includes an open space between the left wheelset and the right wheelset, wherein the frontal end of the curved portion is arranged in a forward projection of the open space.

The term “open space” refers to a space between the wheelsets. Typically, there are no wheels in the open space. However, the open space may typically not be completely empty. For example, a shaft of the axle may extend through the open space. Nevertheless, the open space should generally have a much lower resistance to air flow than the wheels. Preferably, the open space can form a passthrough for air between the wheelsets.

According to an embodiment, the curved portion includes a rear end, wherein the rear end is arranged outward from the forward projection of the open space. The rear end of the curved portion may be arranged in a forward projection of one of the wheelsets.

According to an embodiment, the open space is limited with respect to the lateral axis by an inner wheelset end of the left wheelset and an inner wheelset end of the right wheelset, wherein the frontal end of the curved portion is arranged at a distance to the closest of the inner wheelset ends with respect to the lateral axis, wherein the distance is at least 10 cm. According to an embodiment, the distance is at least 20 cm.

The curved portion can preferably be located at least in part between the inner wheelset ends with respect to the lateral direction.

According to an embodiment, the curved portion is a first curved portion and the aerodynamic skirt includes a second curved portion, wherein the second curved portion includes a frontal end and is curved inward from the frontal end in the rearward direction, wherein a rearward tangent vector at any given position of the second curved portion is directed inward. A curved portion with this shape has the effect that it pulls air in the inward direction while driving. This can be used to advantageously direct the air and, thus, to further reduce the overall drag. Preferably, the second curved portion may be arranged in front of the first curved portion.

According to an embodiment, the second curved portion is arranged in front of the first curved portion in such a way that air flowing along the second curved portion is directed toward the first curved portion. This increases the beneficial effects of the first curved portion, such as described above.

According to an embodiment, the aerodynamic skirt includes a third curved portion, wherein the third curved portion includes a frontal end and is curved outward from the frontal end in the rearward direction, wherein a rearward tangent vector at any given position of the third curved portion is directed inward, wherein the third curved portion is arranged between the first curved portion and the second curved portion. This can further increase the amount of air hitting the first curved portion and thus further improve its beneficial aerodynamic effects, such as described above.

According to an embodiment, the aerodynamic skirt is a first aerodynamic skirt, and the vehicle includes a right-hand side and a left-hand side divided by the central plane, wherein the vehicle includes a second aerodynamic skirts on the same of the right-hand side and the left-hand side as the first aerodynamic skirt.

According to an embodiment, the second aerodynamic skirt is arranged in front of the first aerodynamic skirt.

According to an embodiment, the second aerodynamic skirt includes a rear end, and the first aerodynamic skirt includes a frontal end, wherein the rear end of the second aerodynamic is arranged inward of the frontal end of the first aerodynamic skirt.

According to an embodiment, the rear end of the second aerodynamic is arranged at least 10 cm, preferably at least 20 cm, inward of the frontal end of the first aerodynamic skirt.

According to an embodiment the second aerodynamic skirt includes a fourth curved portion, wherein the fourth curved portion includes a frontal end and is curved inward from the frontal end in the rearward direction, wherein a rearward tangent vector at any given position of the fourth curved portion is directed inward.

In general, the vehicle may include more than one, for example two or more than two aerodynamic skirts. One, some, or all of the aerodynamic skirts of the vehicle may include a curved portion, wherein the curved portion includes a frontal end and is curved outward from the frontal end in the rearward direction.

According to an embodiment, the vehicle includes two aerodynamic skirts arranged and shaped symmetrically with respect to the central plane. As the focused air stream tends to flow under the aerodynamic skirt at an inward direction, the symmetrical setup of the two aerodynamic skirts will cause their respective focused air streams to meet around the central plane and thereafter flow together straight toward the open space between the wheels. Thus, the embodiment increases the amount of air flowing through the open space rather than toward the rear wheels.

According to an embodiment, the vehicle includes two aerodynamic skirts on one side of the central plane. This may improve the aerodynamics. Furthermore, the vehicle may include two aerodynamic skirts on each side of the central plane that are arranged and shaped symmetrically with respect to the central plane.

According to an embodiment, the aerodynamic skirt is a first aerodynamic skirt, wherein the vehicle includes a right-hand side and a left-hand side divided by the central plane, wherein the vehicle includes a second aerodynamic skirts on the same of the right-hand side and the left-hand side as the first aerodynamic skirt, wherein the vehicle includes a third aerodynamic skirt and a fourth aerodynamic skirt on the other of the right-hand side and the left-hand side, wherein the aerodynamic skirts are arranged and shaped symmetrically with respect to the central plane.

The vehicle can include a chassis. According to an embodiment, the aerodynamic skirt is positioned under the chassis. This provides for an advantageous aerodynamic setup.

The vehicle may be a trailer or a semi-trailer. The vehicle may be a semi-truck trailer or a straight truck, which is also referred to as a box truck. The vehicle can be, for example, a commercial vehicle, a truck, a passenger car or a bus. The vehicle can be, for example, a road vehicle or a rail vehicle. The vehicle can be, for example, a single vehicle, a tractor for a tractor-trailer combination, a trailer for a tractor-trailer combination, or a tractor-trailer combination. The trailer of or for the tractor-trailer combination can, for example, be a semi-trailer or a full trailer.

A vehicle includes an axle, wherein the axle includes a left wheelset including at least one wheel and a right wheelset including at least one wheel, wherein the wheels include a common axis of rotation. A lateral axis is defined as parallel to the axis of rotation, wherein a central plane is defined as perpendicular to the lateral axis and centered between the left wheelset and the right wheelset, wherein the vehicle includes a forward direction, which is perpendicular to the lateral axis, wherein the vehicle includes a rearward direction opposite to the forward direction, wherein an outward direction is defined as a direction away from the central plane, wherein an inward direction is defined as a direction toward the central plane. The vehicle includes an aerodynamic skirt, wherein the aerodynamic skirt is arranged in a forward projection of the axle, wherein the aerodynamic skirt includes a curved portion, wherein the curved portion includes a frontal end and is curved inward from the frontal end in the rearward direction, wherein a rearward tangent vector at any given position of the curved portion is directed inward.

A curved portion with this shape has the effect that it pulls air in the inward direction while driving. This can be used to advantageously direct the air and, thus, to further reduce the overall drag.

An aerodynamic skirt for being mounted to a vehicle includes a curved portion, wherein the curved portion includes a frontal end and is curved outward from the frontal end in the rearward direction when mounted to the vehicle.

An aerodynamic skirt for being mounted to a vehicle includes a rear end, wherein the aerodynamic skirt is oriented outward in the rearward direction at the rear end of the aerodynamic skirt when mounted to the vehicle. The rear end may serve as a “kick-out” portion at the rear end. The airflow at the rear end will generally be directed outward and is, thus, directed away from the wheels following the rear end of the aerodynamic skirt. This reduces the overall drag.

Any ordinal numbers used herein, that is, “first”, “second”, “third” and so on, merely simplify reference and are not limiting with respect to the total number of elements for which the ordinal numbers are used or their order of arrangement.

If devices and methods are described herein, the methods described can advantageously be developed further by the embodiments and individual features of the devices, and vice versa. The same applies to different devices.

### BRIEF DESCRIPTION OF DRAWINGS

The invention will now be described with reference to the drawings wherein:

FIG. 1 shows a vehicle in a side view;

FIG. 2 shows a vehicle in a side view;

FIG. 3 shows a vehicle in a side view;

FIG. 4 shows a vehicle in a bottom view;

FIG. 5 illustrates an embodiment of an aerodynamic skirt;

FIG. 6 illustrates an embodiment of an aerodynamic skirt;

FIG. 7 illustrates an embodiment of an aerodynamic skirt;

FIG. 8 illustrates an embodiment of an aerodynamic skirt;

FIG. 9 shows a vehicle in a bottom view;

FIG. 10 shows a vehicle in a bottom view;

FIG. 11 shows a vehicle in an isometric view;

FIG. 12 shows a vehicle in a bottom view;

FIG. 13 shows two aerodynamic skirts;

FIG. 14 illustrates an embodiment of an aerodynamic skirt; and,

FIG. 15 shows two aerodynamic skirts.

### DETAILED DESCRIPTION

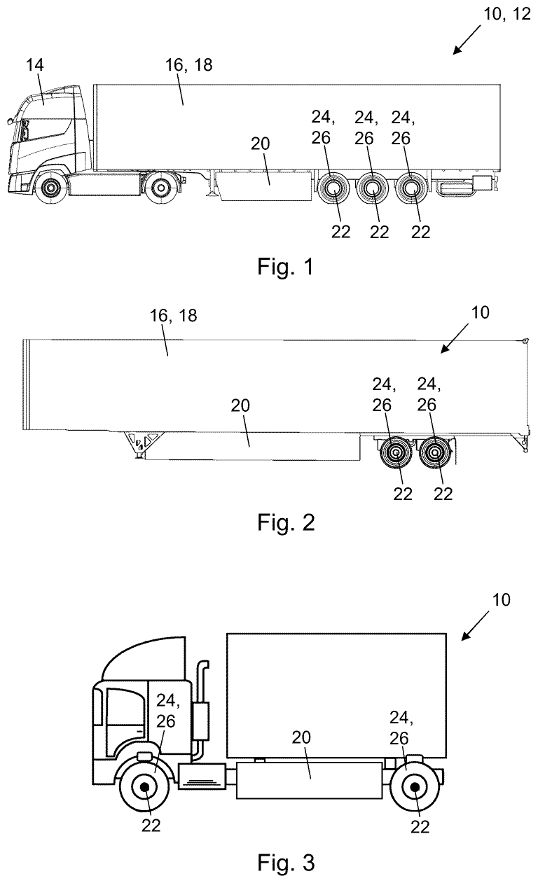

FIG. 1 shows a vehicle 10 in a side view. The vehicle 10 is a semi-truck trailer 12 including a truck 14 and a trailer 16, a semi-trailer 18 in this example. The trailer 14 includes an aerodynamic skirt 20. The trailer 16 includes three axles 22 in this example. Each axle 22 includes a left wheelset 24 including at least one wheel 26 and a right wheelset 28 including at least one wheel 26. In the side view of FIG. 1, the right wheelsets 28 are not visible since they are behind the left wheelsets 24.

FIG. 2 shows a trailer 16 in a side view. The trailer 16 is a semi-trailer 18 in this example. The trailer 14 includes an aerodynamic skirt 20. The trailer 16 includes two axles 22 in this example. Each axle 22 includes a left wheelset 24 including at least one wheel 26 and a right wheelset 28 including at least one wheel 26. In the side view of FIG. 2, the right wheelsets 28 are not visible since they are behind the left wheelsets 24.

FIG. 3 shows another vehicle 10, a straight truck in this example, in a side view. The vehicle 10 includes an aerodynamic skirt 20. The vehicle 10 includes two axles 22 in this example. Each axle 22 includes a left wheelset 24 including at least one wheel 26 and a right wheelset 28 including at least one wheel 26. In the side view of FIG. 3, the right wheelsets 28 are not visible since they are behind the left wheelsets 24.

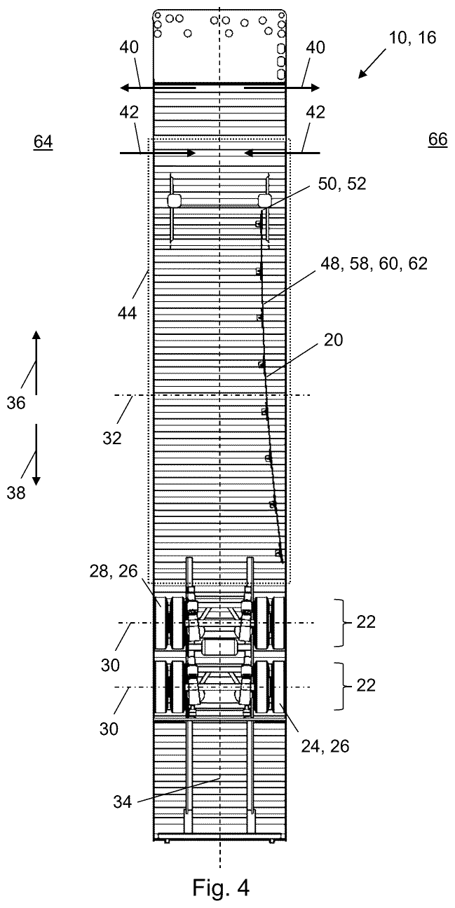

FIG. 4 shows a bottom of a vehicle 10, which is a trailer 16 in this example. The vehicle 16 includes two axles 22 in this example. Each axle 22 includes a left wheelset 24 including at least one wheel 26, two wheels 26 in this example, and a right wheelset 28 including at least one wheel 26, two wheels 26 in this example.

In FIG. 4, the wheels 26 of each axle 22 include a common axis of rotation 30. A lateral axis 32 is defined as parallel to the axis of rotation 30. A central plane 34 is defined as perpendicular to the lateral axis 32 and centered between the left wheelset 24 and the right wheelset 28.

The vehicle 10 of FIG. 4 includes a forward direction 36 indicated as an arrow. The forward direction 36 is perpendicular to the lateral axis 32. The vehicle 10 of FIG. 4 includes a rearward direction 38 opposite to the forward direction 36.

An outward direction 40 is indicated as an arrow in FIG. 4 and is defined as a direction away from the central plane 34. An inward direction 42 is indicated as an arrow in FIG. 4 and is defined as a direction toward the central plane 34.

The vehicle 10 of FIG. 4 includes an aerodynamic skirt 20. The aerodynamic skirt 20 is arranged in a forward projection 44 of the axles 22. The forward projection 44 is indicated as a dotted rectangle in FIG. 4. It should be noted that in FIG. 4 this rectangle is a bit wider than a chassis 46 of the vehicle 10 and than the axles 22. This is only for the sake of visibility. The forward projection 44 generally has the same width as the axle or axles 22.

The aerodynamic skirt 20 of the vehicle 10 of FIG. 4 includes a curved portion 48. The curved portion 48 includes a frontal end 50 and is curved outward from the frontal end 48 in the rearward direction 38.

In the example of FIG. 4, the frontal end 50 of the curved portion 48 is a frontal end 52 of the aerodynamic skirt 20.

In the example of FIG. 4, the curved portion 48 includes a rear end 54 and the rear end 54 of the curved portion 48 is a rear end 56 of the aerodynamic skirt 20.

The curved portion 48 of the aerodynamic skirt 20 of the vehicle 10 of FIG. 4 may include a circular shape 58, a parabolic shape 60 or a spline shape 62.

The vehicle 10 of FIG. 4 includes a right-hand side 64 and a left-hand side 66. Note that in FIG. 4, left and right are inverted, because the vehicle 10 is shown from the bottom.

In FIG. 4, an aerodynamic skirt 20 is only shown on the left-hand side 66 of the vehicle 10. Preferably, though, the vehicle 10 includes an aerodynamic skirt 20 arranged on each side 64 and 66 of the vehicle 10.

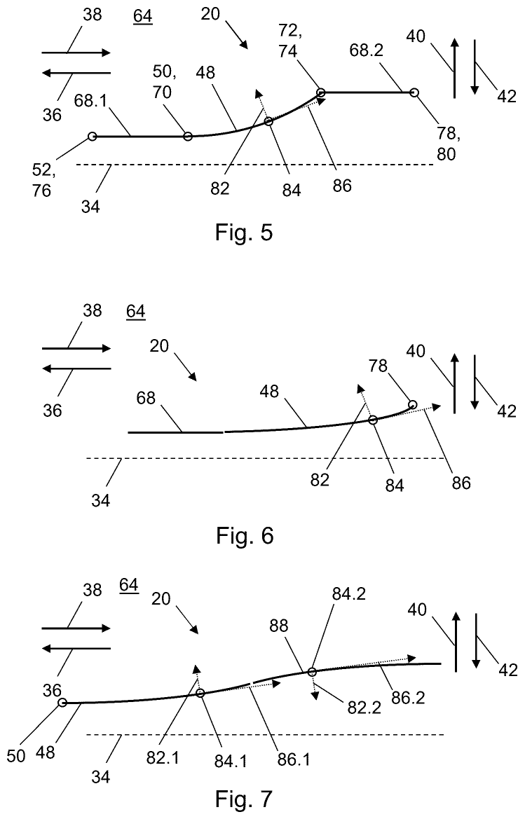

FIGS. 5 to 8 illustrate further examples of an aerodynamic skirt 20 having a curved portion 48 curved outward in the rearward direction. FIGS. 5 to 8 are not to scale. FIGS. 5 to 8 all illustrate an aerodynamic skirt 20 on a right-hand side 64 of the vehicle 10 and show a view from the top.

The aerodynamic skirt 20 of FIG. 5 includes a first straight portion 68.1, a curved portion 48, and a second straight portion 68.2. The curved portion 48 is curved outward in the rearward direction 38. The straight portions 68 are both parallel to the central plane 34, in this example.

In FIG. 5, a frontal end 50 of the curved portion 48 corresponds to, in this example, a rear end 70 of the first straight portion 64.1. A rear end 72 of the curved portion corresponds to, in this example, a frontal end 74 of the second straight portion 68.2.

A frontal end 52 of the aerodynamic skirt 20 of FIG. 5 corresponds to, in this example, a frontal end 76 of the first straight portion 68.1. A rear end 78 of the aerodynamic skirt 20 corresponds to, in this example, a rear end 80 of the second straight portion 68.2.

FIG. 5 further shows a normal vector 82 pointing to the center of curvature at a given position 84 of the curved portion 48. The normal vector 82 pointing to the center of curvature is directed to the left side of the curved portion 48 with respect to the rearward direction 38. The normal vector 82 pointing to the center of curvature is directed outward, that is, away from the central plane 34, due to the curved portion 48 being curved outward from the frontal end 50 in the rearward direction 38.

FIG. 5 further shows a rearward tangent vector 86 at the given position 84 of the curved portion 48. The rearward tangent vector 86 is parallel to the curved portion 48 at the given position and follows the rearward direction 38. The rearward tangent vector 86 is directed outward, that is, away from the central plane 34.

The aerodynamic skirt 20 of FIG. 6 includes a straight portion 68 and a curved portion 48. The curved portion 48 is curved outward in the rearward direction 38 and a rearward tangent vector 86 at any given position 84 of the curved portion 48 is directed outward.

An aerodynamic skirt 20 for a vehicle may preferably be oriented outward in the rearward direction 34 at a rear end 78 of the aerodynamic skirt 20, for example as shown in FIG. 6. Such a rear end 78 may serve as a “kick-out” portion at the rear end 78. The airflow at the rear end 78 will generally be directed outward and is, thus, directed away from the wheels 26 following the rear end 78 of the aerodynamic skirt 20. This reduces the overall drag.

The aerodynamic skirt 20 of FIG. 7 includes a first curved portion 48. The first curved portion 48 is curved outward in the rearward direction 38. The aerodynamic skirt 20 of FIG. 7 further includes a second curved portion 88. The second curved portion 88 is curved inward in the rearward direction 38.

In FIG. 7, a normal vector 82.1 pointing toward the center of curvature at a given position 84.1 of the first curved portion 48 is shown. The normal vector 82.1 pointing toward the center of curvature is directed to the inside of the curved portion 48. The normal vector 82.1 pointing toward the center of curvature is directed to the left side of the first curved portion 48 with respect to the rearward direction 38. The normal vector 82.1 pointing toward the center of curvature is directed outward, that is, away from the central plane 34, due to the curved portion 48 being curved outward from the frontal end 50 of the curved portion 48 in the rearward direction 38.

FIG. 7 shows a rearward tangent vector 86.1 at the given

position 84.1 of the first curved portion 48. The rearward tangent vector 86.1 is parallel to the first curved portion 48 at the given position 84.1 and follows the rearward direction 38. The rearward tangent vector 86.1 is directed outward, that is, away from the central plane 34.

In FIG. 7, a normal vector 82.2 pointing to the center of curvature at a given position 84.2 of the second curved portion 88 is shown. The normal vector 82.2 pointing to the center of curvature is directed to the right side of the second curved portion 88 with respect to the rearward direction 38. The normal vector 82.2 pointing to the center of curvature is directed inward, i.e, toward the central plane 34, due to the curved portion 48 being curved inward in the rearward direction 38.

FIG. 7 shows a rearward tangent vector 86.2 at the given position 84.2 of the second curved portion 88. The rearward tangent vector 86.2 is parallel to the second curved portion 88 at the given position 84.2 and follows the rearward direction 38. The rearward tangent vector 86.2 is directed outward, that is, away from the central plane 34.

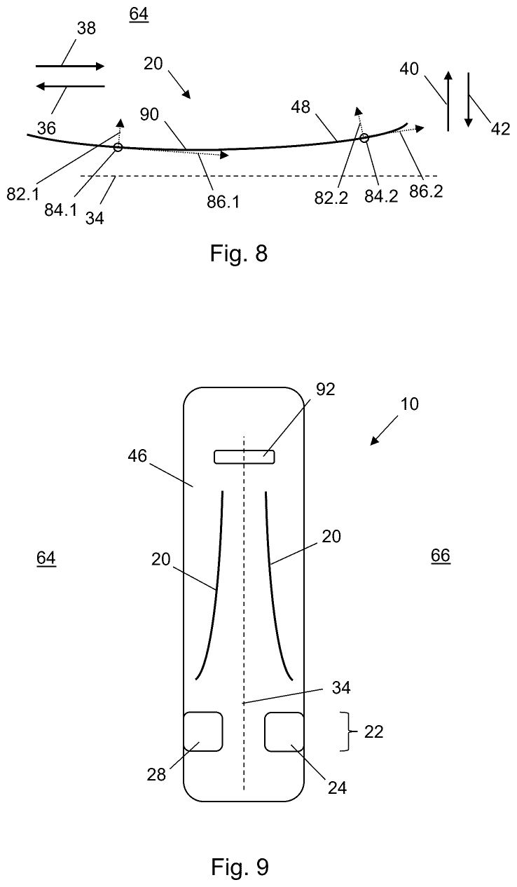

The aerodynamic skirt 20 of FIG. 8 includes a first curved portion 90. The first curved portion 90 is curved outward in the rearward direction 38. The aerodynamic skirt 20 of FIG. 8 further includes a second curved portion 48. The second curved portion 48 is also curved outward in the rearward direction 38.

In FIG. 8, a normal vector 82.1 pointing to the center of curvature at a given position 84.1 of the first curved portion 90 is shown. The normal vector 82.1 pointing to the center of curvature is directed to the left side of the first curved portion 90 with respect to the rearward direction 38. The normal vector 82.1 pointing to the center of curvature is directed outward, that is, away from the central plane 34, due to the curved portion 48 being curved outward in the rearward direction 38.

FIG. 8 shows a rearward tangent vector 86.1 at the given position 84.1 of the first curved portion 90. The rearward tangent vector 86.1 is parallel to the first curved portion 90 at the given position 84.1 and follows the rearward direction 38. The rearward tangent vector 86.1 is directed inward, that is, toward the central plane 34.

In FIG. 8, a normal vector 82.2 pointing to the center of curvature at a given position 84.2 of the second curved portion 48 is shown. The normal vector 82.2 is directed to the left side of the second curved portion 48 with respect to the rearward direction 38. The normal vector 82.2 is directed outward, that is, away from the central plane 34, due to the curved portion 48 being curved outward in the rearward direction 38.

FIG. 8 shows a rearward tangent vector 86.2 at the given position 84.2 of the second curved portion 48. The rearward tangent vector 86.2 is parallel to the second curved portion 48 at the given position 84.2 and follows the rearward direction 38. The rearward tangent vector 86.2 is directed outward, that is, away from the central plane 34.

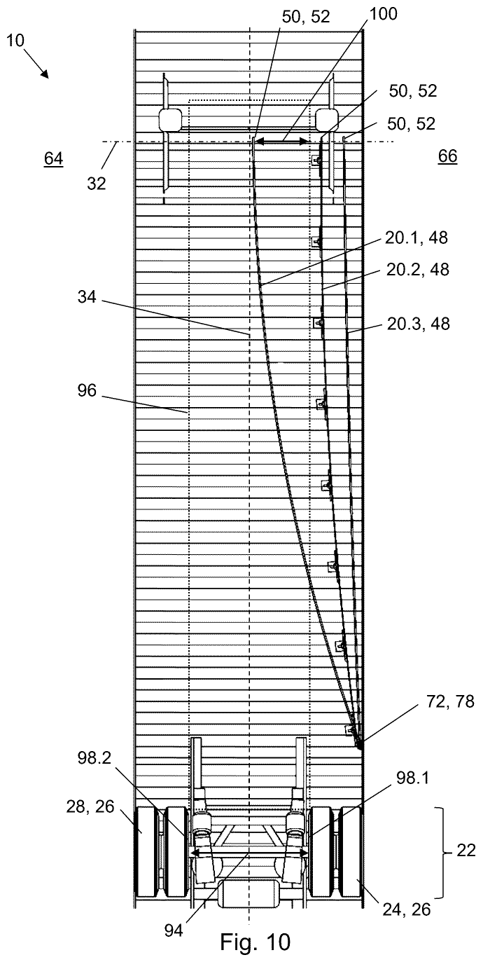

FIG. 9 illustrates another vehicle 10, a semi-trailer in this example, from the bottom. The vehicle 10 includes a chassis 46, an axle 22 with a left wheelset 24 and a right wheelset 28 and a landing gear 92. The vehicle 10 includes two aerodynamic skirts 20 arranged and shaped symmetrically with respect to the central plane 34.

FIG. 10 illustrates another vehicle 10 in a bottom view. The vehicle 10 includes an axle 22 with a left wheelset 24 and a right wheelset 28. In FIG. 10, three aerodynamic skirts 20 are shown and referred to as a first aerodynamic skirt 20.1, a second aerodynamic skirt 20.2, and a third aerodynamic skirt 20.3. As it will be apparent, this is not to suggest that the vehicle 10 should include all three aerodynamic skirts 20. Rather, the three aerodynamic skirts 20 are shown in the same drawing for the sake of comparison.

All three aerodynamic skirts 20.1, 20.2, and 20.3 are, as examples, made up of only one curved portion 48, that is, the frontal end 50 of the curved portion 48 corresponds to the frontal end 52 of the aerodynamic skirt 20 and the rear end 72 of the curved portion corresponds to a rear end 78 of the aerodynamic skirt 20.

Between the left wheelset 24 and the right wheelset 28, there is an open space 94. The open space 94 is open in the sense that it lets air pass much easier than the wheelsets 24, 28. A forward projection 96 of the open space 94 is indicated in FIG. 10 as a dotted rectangle.

The frontal end 50 of the curved portion 48 of the aerodynamic skirt 20.1 is arranged in the forward projection 96 of the open space 94. The rear end 72 of the curved portion 48 of the aerodynamic skirt 20.1 is arranged outward from the forward projection 96 of the open space 94.

The open space 94, as shown in FIG. 10, is limited with respect to the lateral axis 32 by an inner wheelset end 98.1 of the left wheelset 24 and an inner wheelset end 98.2 of the right wheelset 28. The frontal end 50 of the curved portion 48 of the aerodynamic skirt 20.1 is arranged at a distance 100 to the closest of the inner wheelset ends 98 with respect to the lateral axis 32, that is the inner wheelset end 98.1 of the left wheelset 24. The distance 100 may preferably be at least 10 cm, more preferably at least 20 cm.

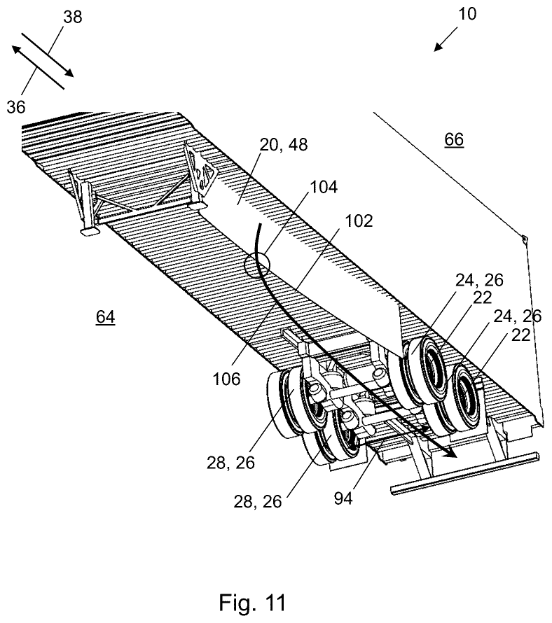

FIG. 11 shows another example of a vehicle 10 in an isometric view. The vehicle 10 includes an axle 22, wherein the axle 22 includes a left wheelset 24 including at least one wheel 26 and a right wheelset 28 including at least one wheel 26. The vehicle 10 includes an aerodynamic skirt 20, wherein the aerodynamic skirt 20 is arranged in a forward projection (not illustrated for the sake of visibility of other features) of the axle 22. The aerodynamic skirt 20 includes a curved portion 48. The curved portion 48 includes a frontal end 50 and is curved outward from the frontal end 50 in a rearward direction 38. A rearward tangent vector at any given position of the curved portion 48 is, in this example, directed outward, that is, away from a central plane (not illustrated for the sake of visibility of other features).

During driving, air generally tends to wrap around the bottom edge 102 of the aerodynamic skirt 20, which increases the amount of air that flows under the vehicle and adds pressure to the vehicle chassis and wheels. The effect is similar to the situation at a wingtip of an airplane, which creates a vortex of flowing air. The amount of air that flows beneath the aerodynamic skirt's bottom edge 102 is increased due to the pressure difference between upwind and downwind side of the aerodynamic skirt. As a result of this pressure difference, a strong vortex wraps around the edge. The vortex causes the fresh air from outside to flow beneath the bottom edge of the panel and under the vehicle. This eventually increases the pressure at the chassis and wheels of the vehicle, which increases the drag.

With the curved portion 48, the air stream flowing under the aerodynamic skirt is rather focused in an area 104 of preferred detachment of the air stream from the skirt's bottom end 102. With a straight aerodynamic skirt, in comparison, the drag toward under the aerodynamic skirt is typically distributed quite evenly along its length.

The air stream 106 resulting from the curved portion 48 according to simulations is shown as an arrow in FIG. 11. As can be seen in FIG. 11, the air stream 106 will generally align with the rearward direction 38 and with the central plane and will pass through the open space 94 between the left wheelset 24 and the right wheelset 28. Between the wheels 26, there is less resistance toward the air flow compared to the area of the wheels 26 themselves. Another result is that the air flowing through the open space between the wheels 26 recovers some pressure behind the vehicle 10. That reduces the overall drag.

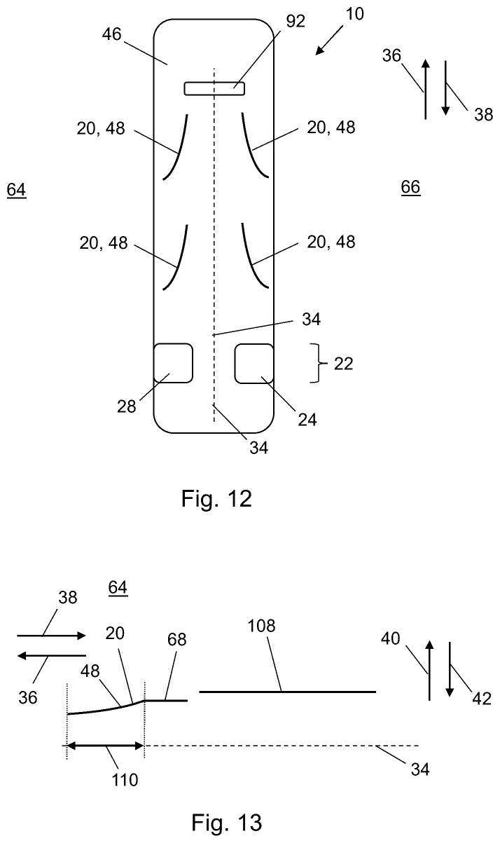

FIG. 12 illustrates another vehicle 10 from the bottom, the vehicle 10 including a chassis 46, an axle 22 with a left wheelset 24 and a right wheelset 28 and a landing gear 92. The vehicle 10 in this example includes four aerodynamic skirts 20, each one including a curved portion 48, wherein the curved portion 48 includes a frontal end and is curved outward from the frontal end in the rearward direction 38. Two of the aerodynamic skirts 20 are arranged on each side of the central plane 34. The aerodynamic skirts 20 are arranged and shaped symmetrically with respect to the central plane 34.

FIG. 13 illustrates a further example, wherein a first aerodynamic skirt 20 and a second aerodynamic skirt 108 are arranged on one side of the central plane 34. In FIG. 13, the aerodynamic skirts 20 and 108 are arranged on a right-hand side 64 of a vehicle and show a view from the top.

In the example of FIG. 13, the first aerodynamic skirt 20 includes a curved portion 48, and a straight portion 68. The curved portion 48 is curved outward in the rearward direction 38 and a rearward tangent vector at any given position of the curved portion 48 is directed outward, that is, away from the central plane 34. The straight portion 68 is parallel to the central plane 34, in this example.

In the example of FIG. 13, the second aerodynamic skirt 108 is completely straight and parallel to the central plane 34.

FIG. 13 further illustrates a length 110 of the curved portion 48 with respect to the rearward direction 38, that is, a length 110 of a lateral projection of the curved portion 48 onto the central plane 34.

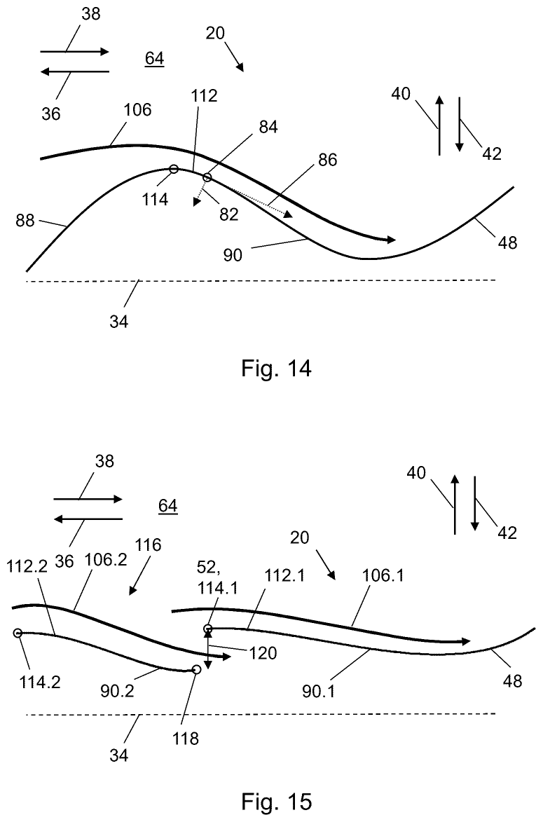

FIG. 14 illustrates a further example of an aerodynamic skirt 20, wherein the aerodynamic skirt 20 is arranged on a right-hand side 64 of a vehicle. FIG. 14 shows a view from the top. While none of the drawings are necessarily true to scale, the curvatures of the aerodynamic skirt 20 are particularly exaggerated in FIG. 14 for the purpose of illustration.

The aerodynamic skirt 20 of FIG. 14 includes a first curved portion 88, a second curved portion 112, a third curved portion 90, and a fourth curved portion 48.

The first curved portion 88 in FIG. 14 is curved inward and a rearward tangent vector (not shown in FIG. 14) at any given position of the first curved portion 88 is directed outward.

The second curved portion 112 in FIG. 14 is curved inward and a rearward tangent vector 86 at a given position 84 of the second curved portion 112 is directed inward. The second curved portion 11 includes a frontal end 114.

The third curved portion 90 in FIG. 14 is curved outward and a rearward tangent vector (not shown in FIG. 14) at any given position of the third curved portion 90 is directed inward.

The fourth curved portion 48 in FIG. 14 is curved outward and a rearward tangent vector (not shown in FIG. 14) at any given position of the fourth curved portion 48 is directed outward.

The second curved portion 112 in FIG. 14 is arranged in front of the third curved portion. The second curved portion 112 is arranged in front of the third curved portion in such a way that air flowing along the second curved portion is directed toward the first curved portion. The third curved portion 90 is arranged between the second curved portion 112 and the fourth curved portion 48.

During driving, the second curved portion 112 has the effect that air flowing along the second curved portion 112 is pulled inward. The resulting air stream 106 is illustrated by an arrow in FIG. 14. Due to this effect, the amount of air hitting the fourth curved portion 48 is increased, which further increases the beneficial effect of the fourth curved portion 48, that is, the focusing effect of the flow detachment at the bottom end of the skirt.

FIG. 15 illustrates a further example, wherein a first aerodynamic skirt 20 and a second aerodynamic skirt 114 are arranged on one side of the central plane 34. In FIG. 15, the aerodynamic skirts 20 and 108 are arranged on a right-hand side 64 of a vehicle and show a view from the top.

In the example of FIG. 15, the second aerodynamic skirt 116 is arranged in front of the first aerodynamic skirt 20.

In FIG. 15, the second aerodynamic skirt 116 includes a rear end 118. The first aerodynamic skirt 20 includes a frontal end 52. The rear end 118 of the second aerodynamic skirt 116 is arranged inward of the frontal end 52 of the first aerodynamic skirt 20. A lateral distance 120 between the rear end 118 of the second aerodynamic skirt and the frontal end 52 of the first aerodynamic skirt is indicated in FIG. 15 as arrow. Preferably, the rear end 118 of the second aerodynamic 116 may be arranged at least 10 cm inward of the frontal end 52 of the first aerodynamic skirt 20, that is, the lateral distance may be at least 10 cm.

The aerodynamic skirt 20 of FIG. 15 includes a first curved portion 112.1, a second curved portion 90.1, and a third curved portion 48. The first curved portion 112 is curved inward and a rearward tangent vector (not shown in FIG. 15) at any given position of the second curved portion 112.1 is directed inward. The first curved portion 112.1 includes a frontal end 114.1 that is also the frontal end 52 of the first aerodynamic skirt 20, in this example. The second curved portion 90.1 is curved outward and a rearward tangent vector (not shown in FIG. 15) at any given position of the second curved portion 90.1 is directed inward. The third curved portion 48 is curved outward and a rearward tangent vector (not shown in FIG. 15) at any given position of the third curved portion 48 is directed outward.

The second aerodynamic skirt 116 of FIG. 15 includes a fourth curved portion 112.2. The fourth curved portion 112.2 includes a frontal end 114.2 and is curved inward from the frontal end in the rearward direction. A rearward tangent vector (not shown in FIG. 15) at any given position of the fourth curved portion 112.2 is directed inward.

The second aerodynamic skirt 116 of FIG. 15 includes a fifth curved portion 90.2. The second curved portion 90.2 is curved outward and a rearward tangent vector (not shown in FIG. 15) at any given position of the second curved portion 90.2 is directed inward.

FIG. 15 further depicts air stream 106.1 and 106.2. Similar to FIG. 14, the air stream 106.1 hits the third curved portion 48 and, thereafter, detaches from the bottom edge of the first aerodynamic skirt and of the third curved portion 48 in a focused manner, such that the air stream will flow toward the central plane, similar to the air stream 106 as shown in FIG. 11.

The air stream 106.2 flows directly behind the first aerodynamic skirt 20. The first curved portion 112.1 and second curved portion 90.1 of the first aerodynamic skirt 20 direct the air stream further inward. This, too, leads to a large amount of air flowing toward the central plane. Since the aerodynamic skirts are preferably arranged symmetrically on both sides, similar to FIG. 12 for example, the opposing air streams will result in a concentrated strong air stream along the central plane in the backward direction. This air stream can easily pass through the open space between the wheels, for example, as illustrated in FIG. 11.

It should be noted that when emphasizing the advantages of a strong central air stream or of a large amount of air flowing toward the central plane, this is to be understood as relative to air flow onto the wheels. Thus, it is generally not the goal to lead as much air as possible in absolute terms through the open space. Rather, the goal is to reduce the amount of air hitting the wheels. This can be achieved basically in two ways. The first is to divert the air in an outward direction away from the wheels. The second is to divert the air, which we cannot prevent from entering the space between the aerodynamic skirts, so far inward that it can easily pass through the open space between the wheels. The curved portions referred to as 48 above do both. Their shape generally directs air flow outward. But there will always be some air flow under the bottom edge into the space behind the skirt. This air gets focused and directed inwardly due to the shape of the curved portions 48 such that it eventually flows through the open space between the wheels instead of hitting the wheels.

Where similar or identical elements are shown in different figures, reference numerals are assigned accordingly. Multiple descriptions of similar or identical elements have been avoided for the sake of clarity. Nevertheless, the embodiments of the figures can be combined with each other and developed further in accordance with the other embodiments and/or their individual features.

It is understood that the foregoing description is that of the preferred embodiments of the invention and that various changes and modifications may be made thereto without departing from the spirit and scope of the invention as defined in the appended claims.

1. A vehicle comprising:
an axle including a left wheelset having at least one wheel and a right wheelset having at least one wheel;
said at least one wheel of said left wheelset and said at least one wheel of said right wheel set having a common axis of rotation, wherein a lateral axis is defined as parallel to the axis of rotation, and wherein a central plane is defined as perpendicular to the lateral axis and centered between said left wheelset and said right wheelset;
the vehicle defining a forward direction which is perpendicular to the lateral axis;
the vehicle defining a rearward direction which is opposite to the forward direction;
wherein an outward direction is defined as a direction away from the central plane;
wherein an inward direction is defined as a direction toward the central plane;
an aerodynamic skirt arranged in a forward projection of said axle;
said aerodynamic skirt including a curved portion; and,
said curved portion including a frontal end and being curved outward from said frontal end in the rearward direction.

2. The vehicle of claim 1, wherein said frontal end of said curved portion is a frontal end of said aerodynamic skirt.

3. The vehicle of claim 1, wherein said curved portion includes a rear end; and, said rear end of said curved portion is a rear end of said aerodynamic skirt.

4. The vehicle of claim 1, wherein said curved portion includes a circular shape, a parabolic shape or a spline shape.

5. The vehicle of claim 1, wherein a rearward tangent vector at any given position of said curved portion is directed outward.

6. The vehicle of claim 1, wherein said axle includes an open space between said left wheelset and said right wheelset; and, said frontal end of said curved portion is arranged in a forward projection of said open space.

7. The vehicle of claim 6, wherein said curved portion includes a rear end; and, said rear end is arranged outward from said forward projection of said open space.

8. The vehicle of claim 6, wherein said open space is limited with respect to the lateral axis by a left inner wheelset end of said left wheelset and a right inner wheelset end of said right wheelset; said frontal end of said curved portion is arranged at a distance to a closest of said left inner wheel set end and said right inner wheelset end with respect to the lateral axis; and, said distance is at least 10 cm.

9. The vehicle of claim 8, wherein said distance is at least 20 cm.

10. The vehicle of claim 1, wherein:
said curved portion is a first curved portion;
said aerodynamic skirt includes a second curved portion;
said second curved portion includes a second frontal end and is curved inward from said second frontal end in the rearward direction;
a rearward tangent vector at any given position of said second curved portion is directed inward; and,
said second curved portion is arranged in front of said first curved portion.

11. The vehicle of claim 10, wherein said second curved portion is arranged in front of said first curved portion such that air flowing along said second curved portion is directed toward said first curved portion.

12. The vehicle of claim 10, wherein the aerodynamic skirt includes a third curved portion; said third curved portion includes a third frontal end and is curved outward from said third frontal end in the rearward direction;
a rearward tangent vector at any given position of said third curved portion is directed inward; and, said third curved portion is arranged between said first curved portion and said second curved portion.

13. The vehicle of claim 1, wherein said aerodynamic skirt is a first aerodynamic skirt; the vehicle has a right-hand side and a left-hand side divided by the central plane; the vehicle further comprising:
a second aerodynamic skirt on a same of said right-hand side and said left-hand side as said first aerodynamic skirt.

14. The vehicle of claim 13, wherein said second aerodynamic skirt is arranged in front of said first aerodynamic skirt.

15. The vehicle of claim 13, wherein said second aerodynamic skirt includes a rear end; said first aerodynamic skirt has a frontal end; and, said rear end of said second aerodynamic skirt is arranged inward of said frontal end of said first aerodynamic skirt.

16. The vehicle of claim 15, wherein said rear end of said second aerodynamic skirt is arranged at least 10 centimeters inward of said frontal end of said first aerodynamic skirt.

17. The vehicle of claim 13, wherein said second aerodynamic skirt includes a fourth curved portion; said fourth curved portion has a fourth frontal end and is curved inward from said fourth frontal end in the rearward direction; and, a rearward tangent vector at any given position of said fourth curved portion is directed inward.

18. The vehicle of claim 1, wherein said aerodynamic skirt is a first aerodynamic skirt, the vehicle further comprising a second aerodynamic skirt; and said first aerodynamic skirt and said second aerodynamic skirt are arranged and shaped symmetrically with respect to the central plane.

19. The vehicle of claim 1, wherein said aerodynamic skirt is a first aerodynamic skirt, the vehicle has a right-hand side and a left-hand side divided by the central plane, the vehicle further comprising:
a second aerodynamic skirt on a first side of said right-hand side and said left-hand side as said first aerodynamic skirt;
a third aerodynamic skirt and a fourth aerodynamic skirt on a second side of the right-hand side and the left-hand side; and,
wherein said first aerodynamic skirt, said second aerodynamic skirt, said third aerodynamic skirt, and said fourth aerodynamic skirt are arranged and shaped symmetrically with respect to the central plane.

20. The vehicle of claim 1, wherein the vehicle is a trailer.

21. The vehicle of claim 1, wherein the vehicle is a semi-trailer.

22. A vehicle comprising:
an axle;
said axle including a left wheelset having at least one wheel and a right wheelset having at least one wheel;
said at least one wheel of said left wheelset and said at least one wheel of said right wheel set having a common axis of rotation; wherein a lateral axis is defined as parallel to the axis of rotation, and wherein a central plane is defined as perpendicular to the lateral axis and centered between said left wheelset and said right wheelset;
the vehicle defining a forward direction, which is perpendicular to the lateral axis;
the vehicle defining a rearward direction opposite to the forward direction;
an outward direction being defined as a direction away from the central plane;
an inward direction being defined as a direction toward the central plane;
an aerodynamic skirt;
said aerodynamic skirt being arranged in a forward projection of said axle;
said aerodynamic skirt including a curved portion;
said curved portion including a frontal end and being curved inward from said frontal end in the rearward direction; and,
a rearward tangent vector at any given position of said curved portion being directed inward.

23. An aerodynamic skirt for being mounted to a vehicle, the aerodynamic skirt comprising:
an aerodynamic skirt body having a rear end; and,
wherein the aerodynamic skirt is oriented outward in a rearward direction at said rear end of said aerodynamic skirt body when mounted to the vehicle.
